(19) United States
(12) Patent Application Publication
(10) Pub. No.: US 2011/0076002 A1
(43) Pub. Date: Mar. 31, 2011

(54) Image Capturing Device and Method

(76) Inventor: Chien-Ming Lai, Tan-Tzu Hsiang (TW)

(21) Appl. No.: 12/887,619

(22) Filed: Sep. 22, 2010

(30) Foreign Application Priority Data
Sep. 29, 2009 (TW) 098132924

(51) Int. Cl. G03B 7/00

(52) U.S. Cl. 396/213

(57) ABSTRACT

An image capturing device includes an image sensing unit, a shutter button mechanism, and a control unit. The image sensing unit includes a lens module and an image sensor. The shutter button mechanism is operable to generate a trigger signal when pressed and to generate a release signal when the shutter button mechanism is released after being pressed. The control unit is configured to perform, in response to the release signal from the shutter button mechanism, a picture taking procedure for controlling the image sensing unit to capture an image.

### CROSS-REFERENCE TO RELATED APPLICATION

This application claims priority of Taiwanese Application No. 098132924, filed on Sep. 29, 2009.

### BACKGROUND OF THE INVENTION

1. Field of the Invention

The present invention relates to an image capturing device and method that minimize blurring of captured images.

2. Description of the Related Art

When taking pictures with digital cameras, pressing of a shutter button mechanism usually shakes the camera and may result in blurry captured image. Many techniques have been proposed to solve this problem, such as optical compensation or image processing compensation. However, the optical compensation technique increases the manufacturing cost of cameras, whereas the image processing compensation technique has limited effect. Another technique is to introduce a time delay after the shutter button mechanism is pressed when capturing images. However, users are unable to grasp the timing of taking pictures and may lose opportunities of capturing instantaneous images.

### SUMMARY OF THE INVENTION

Therefore, an object of the present invention is to provide an image capturing device and method that may minimize blurring of captured images.

Accordingly, an image capturing device of the present invention includes an image sensing unit, a shutter button mechanism, and a control unit.

The shutter button mechanism is operable to generate a trigger signal when pressed and to generate a release signal when the shutter button mechanism is released after being pressed.

The control unit is coupled to the image sensing unit and the shutter button mechanism, and is configured to perform, in response to the release signal from the shutter button mechanism, a picture taking procedure for controlling the image sensing unit to capture an image.

According to another aspect, an image capturing method of the present invention is to be performed using an image capturing device includes an image sensing unit, a shutter button mechanism, and a control unit coupled to the image sensing unit and the shutter button mechanism. The image sensing unit includes a lens module, and an image sensor for capturing images via the lens module. The shutter button mechanism is operable to generate a release signal when the shutter button mechanism is released after being pressed. The control unit is configured to perform a picture taking procedure for controlling the image sensing unit to capture an image. The image capturing method includes:

configuring the control unit to perform the picture taking procedure in response to the release signal from the shutter button mechanism.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view illustrating a preferred embodiment of an image capturing device and method of the present invention;

FIG. 2 is a block diagram illustrating an image sensing unit, a shutter button mechanism, and a control unit of the preferred embodiment; and

FIG. 3 is a flowchart illustrating operation of the control unit of the preferred embodiment.

### DETAILED DESCRIPTION OF THE PREFERRED EMBODIMENT

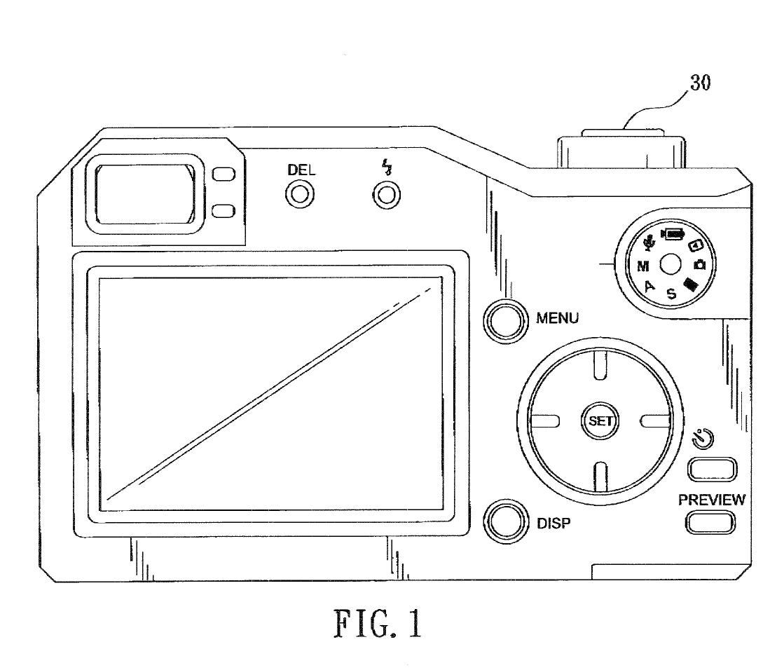

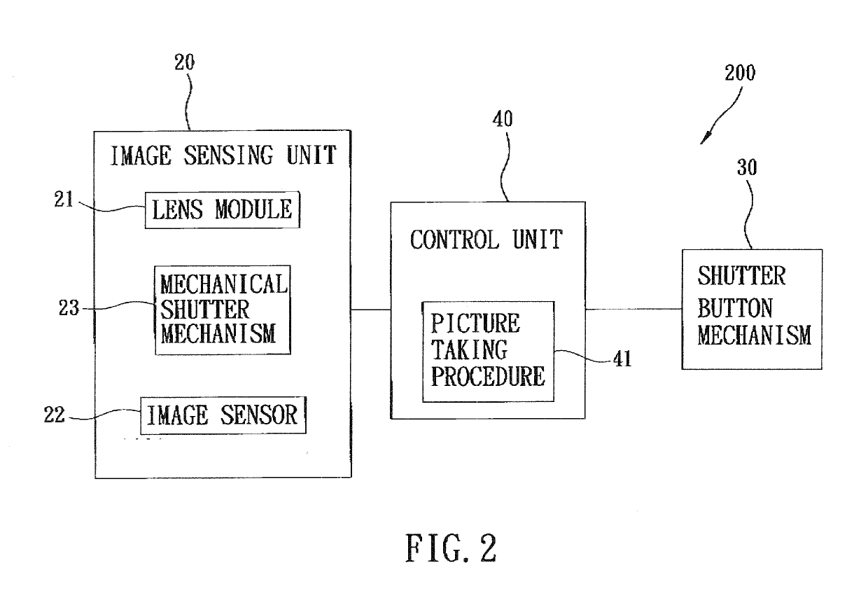

Referring to FIG. 1 and FIG. 2, a preferred embodiment of an image capturing device 200 of the present invention includes an image sensing unit 20, a shutter button mechanism 30, and a control unit 40.

The image sensing unit 20 includes a lens module 21, an image sensor 22 for capturing images via the lens module 21, and a mechanical shutter mechanism 23.

The shutter button mechanism 30 is operable to generate a trigger signal when pressed and to generate a release signal when the shutter button mechanism 30 is released after being pressed. The shutter button mechanism 30 is one of a mechanical switch mechanism and a touch panel in this embodiment.

The control unit 40 is coupled to the image sensing unit 20 and the shutter button mechanism 30 and is configured to perform, in response to the release signal from the shutter button mechanism 30, a picture taking procedure 41 for controlling the image sensing unit 20 to capture an image. In this embodiment, the control unit 40 controls the mechanical shutter mechanism 23 for image capturing and further controls activation and subsequent deactivation of the image sensor 22 when the control unit 40 performs the picture taking procedure 41.

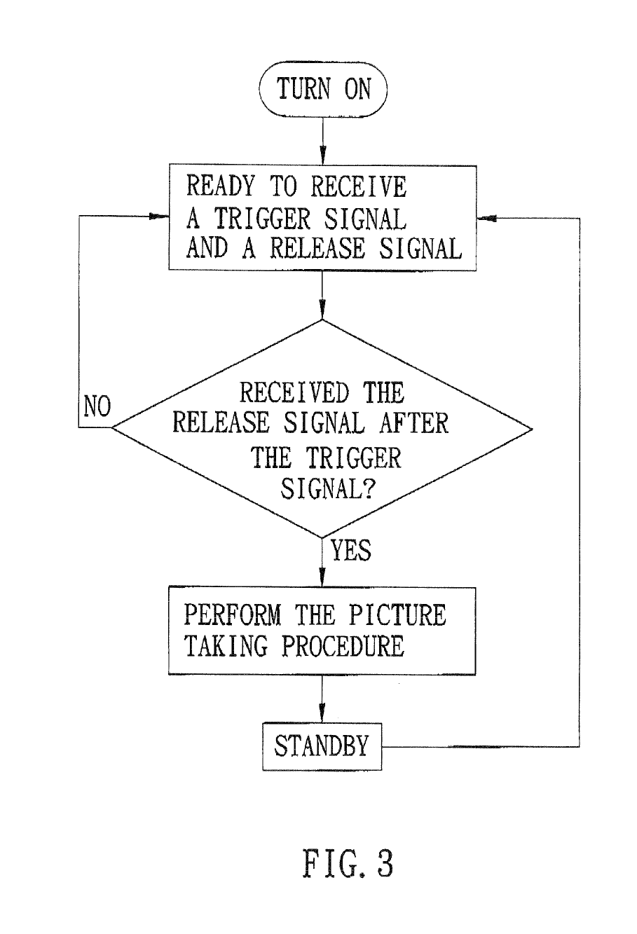

Referring to FIG. 2 and FIG. 3, the image capturing method of this invention is to be performed using the image capturing device 200 that includes the image sensing unit 20, the shutter button mechanism 30, and the control unit 40 coupled to the image sensing unit 20 and the shutter button mechanism 30. The image sensing unit 20 includes the lens module 21, the image sensor 22 for capturing images via the lens module 21, and the mechanical shutter mechanism 23. The shutter button mechanism 30 is operable to generate a trigger signal when pressed and to generate a release signal when the shutter button mechanism 30 is released after being pressed. The control unit 40 is configured to perform the picture taking procedure 41 for controlling the image sensing unit 20 to capture an image. The image capturing method includes:

configuring the control unit 40 to perform the picture taking procedure 41 in response to the release signal from the shutter button mechanism 30. In this embodiment, the control unit 40 is configured to control the image sensor 22 and the mechanical shutter mechanism 23 for image capturing when the control unit 40 performs the picture taking procedure 41.

When taking pictures, the shutter button mechanism 30 is operable to generate a trigger signal when pressed and to generate a release signal when the shutter button mechanism 30 is released after being pressed. In this way, the image sensor 22 captures an image without disturbance distributed to pressing of the shutter button mechanism 30, and blurring the captured image may be minimized accordingly.

Furthermore, the control unit 40 may be configured to control activation and subsequent deactivation of the image sensor 22 as an electronic shutter mechanism instead of adopting the mechanical shutter mechanism 23 when the control unit 40 performs the picture taking procedure 41, in other embodiments of this invention.

Moreover, digital cameras designed such that half-pressing of a shutter button mechanism allows auto-focusing to be performed are known in the art. The present invention may be combined with the conventional function, i.e., performing auto-focusing before the release signal is generated, in other embodiments of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An image capturing device comprising:
an image sensing unit;
a shutter button mechanism operable to generate a trigger signal when pressed and to generate a release signal when said shutter button mechanism is released after being pressed; and
a control unit coupled to said image sensing unit and said shutter button mechanism and configured to perform, in response to the release signal from said shutter button mechanism, a picture taking procedure for controlling said image sensing unit to capture an image.

2. The image capturing device as claimed in claim 1, wherein said image sensing unit includes a lens module, and an image sensor for capturing images via said lens module.

3. The image capturing device as claimed in claim 1, wherein said image sensing unit includes a mechanical shutter mechanism controlled by said control unit for image capturing when said control unit performs the picture taking procedure.

4. The image capturing device as claimed in claim 2, wherein said control unit is configured to control activation and subsequent deactivation of said image sensor when said control unit performs the picture taking procedure.

5. The image capturing device as claimed in claim 1, wherein said shutter button mechanism includes one of a mechanical switch mechanism and a touch panel.

6. An image capturing method to be performed using an image capturing device, the image capturing device including
an image sensing unit that includes a lens module, and an image sensor for capturing images via the lens module,
a shutter button mechanism operable to generate a trigger signal when pressed and to generate a release signal when the shutter button mechanism is released after being pressed, and
a control unit coupled to the image sensing unit and the shutter button mechanism and configured to perform a picture taking procedure for controlling the image sensing unit to capture an image,
said image capturing method comprising:
configuring the control unit to perform the picture taking procedure in response to the release signal from the shutter button mechanism.

7. The image capturing method as claimed in claim 6, wherein the control unit is configured to control the image sensor for image capturing when the control unit performs the picture taking procedure.

8. The image capturing method as claimed in claim 6, the image sensing unit further including a mechanical shutter mechanism, wherein the control unit is configured to control the mechanical shutter mechanism for image capturing when the control unit performs the picture taking procedure.

9. The image capturing method as claimed in claim 6, wherein the control unit is configured to control activation and subsequent deactivation of the image sensor when the control unit performs the picture taking procedure.
